(19) United States
(12) Patent Application Publication
(10) Pub. No.: US 2009/0314752 A1
(43) Pub. Date: Dec. 24, 2009

(54) IN-SITU MONITORING FOR LASER ABLATION

(75) Inventors: ANTOINE P. MANENS, Sunnyvale, CA (US); Wei-Yung Hsu, Santa Clara, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/430,345

(22) Filed: Apr. 27, 2009

Related U.S. Application Data
(60) Provisional application No. 61/053,153, filed on May 14, 2008.

(51) Int. Cl. B23K 26/03; B23K 26/38

(52) U.S. Cl. 219/121.69; 219/121.83

(57) ABSTRACT

In a system where scribe lines are formed by a series of partially-overlapping ablation spots, discontinuities can be detected by capturing an intensity of light generated during each instance of ablation for a respective spot. In any instance where the intensity of light given off falls below a desired threshold, such that the ablation spot might not sufficiently overlap any adjacent spot, the position of that instance can be captured such that another attempt at ablation can be carried out at that location.

### CROSS-REFERENCE TO RELATED APPLICATIONS

This application claims the benefit of U.S. Provisional Application No. 61/053,153, filed May 14, 2008. This application is related to co-pending U.S. Provisional Patent Application No. 61/044,021, filed Apr. 10, 2008, entitled “Laser Scribing Platform.” Each of these applications is hereby incorporated herein by reference.

### BACKGROUND

Various embodiments described herein relate generally to the ablation of materials, as well as methods and systems for ablating such materials. These methods and systems can be particularly effective in scribing workpieces such as single-junction solar cells and thin-film multi-junction solar cells.

Current methods for forming thin-film solar cells involve depositing or otherwise forming a plurality of layers on a substrate, such as a glass, metal or polymer substrate suitable to form one or more p-n junctions. An example of a solar cell has an oxide layer (e.g., a transparent-conductive-oxide (TCO) layer) deposited on a substrate, followed by an amorphous-silicon layer and a metal back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a panel is being formed from a large substrate, a series of scribe lines is typically used within each layer to delineate the individual cells.

In some systems, scribe lines are formed using a series of pulses from a laser directed toward at least one layer on a workpiece. Each pulse is directed to, and focused at, the one or more layers to be ablated, with the pulse having sufficient intensity to ablate a “spot” or substantially circular region or trench in the one or more layers. The ablated material is directed away from the workpiece in a “plume” of debris. Unfortunately, due to a number of variable factors, not every spot in a scribe line is properly formed. In some instances, such as may be due to the occurrence of a defect in the workpiece and/or a defective laser pulse, a spot might not even be formed. Such improperly-formed spots can create discontinuities in the scribe lines, which can reduce the efficiency of the overall solar-cell array. Further, in solar panels where scribe lines are formed from a billion or more ablated spots, it can be especially time consuming to attempt to locate and correct any individual discontinuity.

Accordingly, it is desirable to develop systems and methods that overcome at least some of these, as well as potentially other, deficiencies in existing ablating, scribing, and/or solar-panel manufacturing devices.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Systems for laser scribing a workpiece are provided that include a detector for monitoring laser ablations. By monitoring the light generated during an ablation, a system can gather data that is indicative of the amount of ablation at each respective position. The data can be used for a variety of purposes, such as for quality control and/or remedial actions, such as reworking the workpiece by re-ablating or otherwise repairing locations on the workpiece where the data is indicative of a defect. The systems provided can be especially beneficial when used during the manufacture of solar cells, such as single-junction solar cells and thin-film multi-junction solar cells.

In an embodiment, a system for scribing a workpiece is provided. The system includes a laser for directing a series of laser pulses towards a plurality of partially-overlapping positions on a layer of material on the workpiece. Each laser pulse is capable of triggering ablation of the layer of material at one of the positions. The system further includes a detector for detecting an intensity of light generated during the ablation, the intensity of light being indicative of the amount of ablation at each respective position.

In another embodiment, a method of scribing a workpiece is provided. The method includes directing a series of laser pulses toward a plurality of partially-overlapping positions on a layer of material on the workpiece. Each laser pulse is capable of triggering ablation of the layer of material at one of the positions. The method further includes detecting an intensity of light generated during the ablation, the intensity of light being indicative of the amount of ablation at each respective position. In another embodiment, an article is provide that includes instructions stored thereon, which instructions when executed result in the performance of the above described method.

For a fuller understanding of the nature and advantages of the present invention, reference should be made to the ensuing detailed description and accompanying drawings. Other aspects, objects and advantages of the invention will be apparent from the drawings and the detailed description that follows.

### BRIEF DESCRIPTION OF THE DRAWINGS

Various embodiments in accordance with the present invention will be described with reference to the drawings, in which:

FIG. 1 illustrates a perspective view of a laser-scribing device that can be used in accordance with many embodiments;

FIG. 2 illustrates an end view of a laser-scribing device that can be used in accordance with many embodiments;

FIGS. 3(a) and 3(b) illustrate an approach for scribing longitudinal trim lines on a workpiece that can be used in accordance with many embodiments;

FIG. 4 illustrates layers of a solar cell with scribe lines that can be formed in accordance with many embodiments;

FIGS. 5(a) and 5(b) illustrate discontinuities in scribe lines that can be addressed in accordance with many embodiments;

FIG. 6 illustrates a configuration for ablating material from a workpiece that can be used in accordance with many embodiments;

FIG. 7 illustrates intensity peaks that can be used in accordance with many embodiments;

FIG. 8 illustrates a configuration of a laser-scribing device that can be used in accordance with many embodiments;

FIG. 9 illustrates a configuration for laser ablation that can be used in accordance with many embodiments;

FIG. 10 illustrates spectral peaks that can be generated and analyzed in accordance with many embodiments;

FIG. 11 illustrates a pattern for correcting a discontinuity that can be used in accordance with many embodiments; and

FIG. 12 illustrates a control system that synchronizes the position of laser ablations with the movement of a workpiece in accordance with many embodiments.

### DETAILED DESCRIPTION OF THE INVENTION

Systems and methods in accordance with various embodiments of the present disclosure can overcome one or more of the aforementioned and other deficiencies in existing approaches to ablation and/or laser scribing. Various embodiments can provide for improved process control, as well as the ability determine in-situ the presence and location of discontinuities or improper ablation regions. Devices in accordance with various embodiments are then able to return to these locations to attempt to correct for problems in the ablation process.

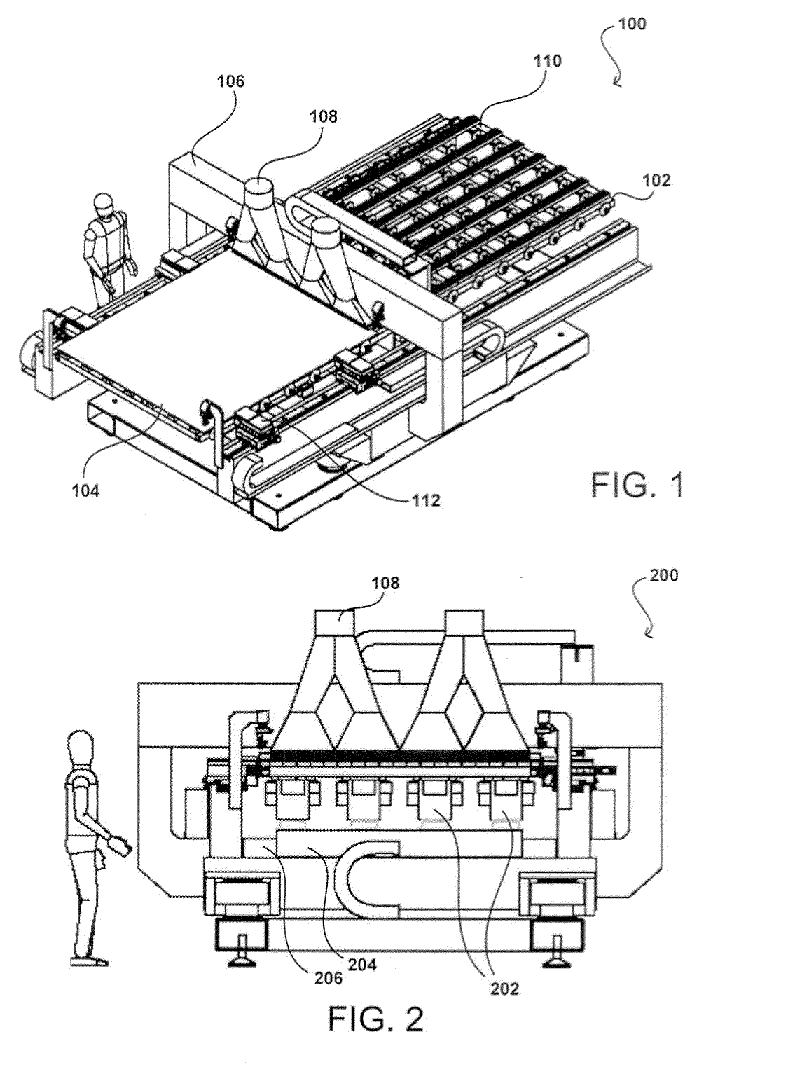

FIG. 1 illustrates an example of a laser-scribing device 100 that can be used in accordance with many embodiments. The device includes a bed or stage 102, which will typically be leveled, for receiving and maneuvering a workpiece 104, such as a substrate having at least one layer deposited thereon. In one example, a workpiece is able to move along a single directional vector (i.e., for a Y-stage) at a rate of up to and/or greater than 2 m/s. Typically, the workpiece will be aligned to a fixed orientation with the long axis of the workpiece substantially parallel to the motion of the workpiece in the device, for reasons described elsewhere herein. The alignment can be aided by the use of cameras or imaging devices that acquire marks on the workpiece. In this example, the lasers (shown in subsequent figures) are positioned beneath the workpiece and opposite a bridge 106 holding part of an exhaust mechanism 108 for extracting material ablated or otherwise removed from the substrate during the scribing process. The workpiece 104 typically is loaded onto a first end of the stage 102 with the substrate side down (towards the lasers) and the layered side up (towards the exhaust). The workpiece is received onto an array of rollers 110 and/or bearings, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assembly. The device can include at least one controllable drive mechanism 112 for controlling a direction and translation velocity of the workpiece 104 on the stage 102.

As the substrate is translated back and forth on the stage 102, a scribing area of the laser assembly effectively scribes from near an edge region of the workpiece to near an opposite-edge region of the workpiece. In order to ensure that the scribe lines are being formed properly, an imaging device can image at least one of the lines after scribing. Further, a beam-profiling device can be used to calibrate the beams between processing of workpieces or at other appropriate times. In an embodiment where scanners are used, for example, which drift over time, a beam profiler allows for the calibrating of the beam and/or adjustment of beam position. The stage, bridge, and a base portion can be made out of at least one appropriate material, such as a base portion of granite.

FIG. 2 illustrates an end view 200 of such a device, illustrating a series of laser assemblies 202 used to scribe the layers of the workpiece. In this example, there are four laser assemblies 202, each including a laser device and elements, such as lenses and other optical elements, needed to focus or otherwise adjust aspects of the laser. Each laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage translates the workpiece along a longitudinal axis. The lasers then can be attached to a translation mechanism able to laterally translate the lasers relative to the longitudinal axis. For example, the lasers can be mounted on a support 204 that is able to translate on a lateral rail 206 as driven by a controller and servo motor. In some embodiments, the lasers and laser optics all move together laterally on the support. As discussed below, this allows shifting scan areas laterally and provides other advantages.

Each laser device can produce multiple effective beams, through the use of elements such as beam splitters, that are useful for scribing the workpiece. Each portion of the exhaust can cover a scan field, or an active area, of the beams from a common laser device in this example, although the exhaust could be further broken down to have a separate portion for the scan field of each individual beam. The device also can include substrate-thickness sensors useful in adjusting heights in the system to maintain proper separation from the substrate due to variations between substrates and/or in a single substrate. Each laser can be adjustable in height (e.g., along the z-axis) using a z-stage, motor, and controller, for example. In some embodiments, the system is able to handle 3-5 mm differences in substrate thickness, although many other such adjustments are possible. The z-motors also can be used to adjust the focus of each laser on the workpiece by adjusting the vertical position of the laser itself.

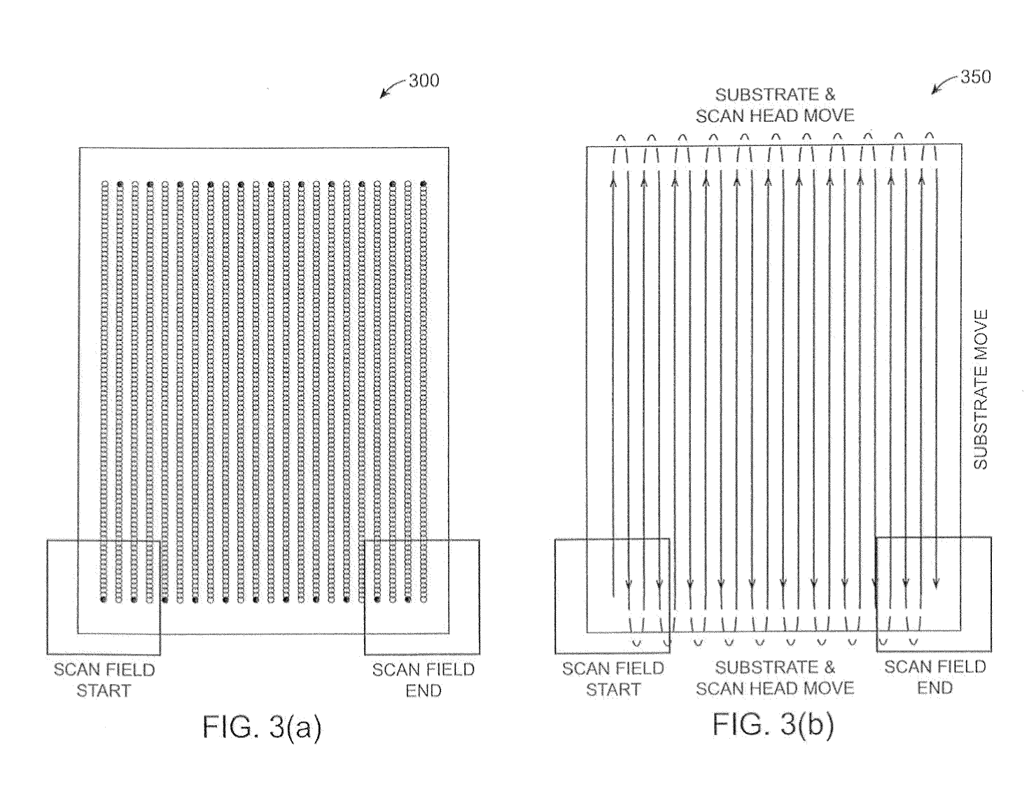

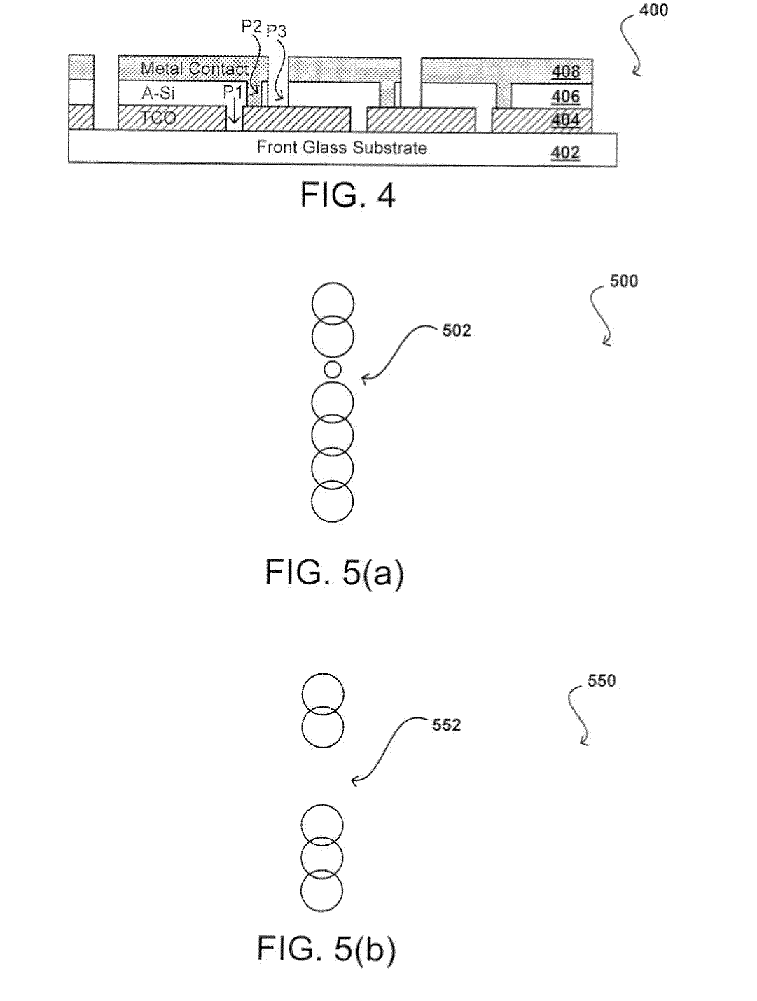

FIGS. 3(a) and 3(b) illustrate an exemplary approach that can be used to form longitudinal scribe lines on the workpiece. As shown in the illustration 350 of FIG. 3(b), the workpiece can be moved back and forth longitudinally and only one scribe line can be formed at any given time for any laser-beam portion or scan field. The position of the scan field can be adjusted at the end of each line. Each scribe line can be formed by ablating material at each of a sequence of locations along the scribe pattern during movement of the workpiece, forming a line of overlapping spots, as shown in the illustration 300 of FIG. 3(a). The spots overlap by an amount, such as 25% by area, that ensures proper region isolation in a layer, of between parts of a cell, while minimizing the number of spots that must be formed in order to ensure acceptable throughput. Various methods of calibrating scribing devices are known, which can provide a level of control of the positioning of the spots on the workpiece. In the case of thin-film solar-cell panels, a number of different scribe lines can be used in different layers to provide for proper isolation between layer regions of different cells. FIG. 4 illustrates an example structure 400 of a set of thin-film solar cells that can be formed in accordance with many embodiments. In this example, a glass substrate 402 has deposited thereon a transparent-conductive-oxide (TCO) layer 404, which then has scribed therein a pattern of first scribe lines (e.g., scribe 1 lines or P1 lines). An amorphous-silicon layer 406 is then deposited, and a pattern of second scribe lines (e.g., scribe 2 lines or P2 lines) formed therein. A metal back layer 408 then is deposited, and a pattern of third scribe lines (e.g., scribe 3 lines or P3 lines) formed therein. The area between adjacent P1 and P3 (including P2 there between) lines is a non-active area, or dead zone, which is desired to be minimized in order to improve efficiency of the overall array. Accordingly, it is desirable to control the spot size and positioning during the scribing process.

As discussed, each scribe line in many embodiments is formed by creating an “overlapping” series of ablation spots that desirably form a continuous segment. Certain errors or problems can occur, however, which can cause the scribe lines to be discontinuous. Discontinuities in the scribe lines are undesirable, as they can significantly reduce the electrical isolation between adjacent regions and thus decrease the overall efficiency of the panel. As illustrated in the example 500 of FIG. 5(a), it is possible that an ablation spot 502 is formed that is too small, such that gaps are left between that spot and at least one adjacent spot, or the spots do not overlap enough to provide sufficient isolation. In other cases, the spot may be too large and may reduce the efficiency of the solar cells by reducing the active area of the adjacent cells. FIG. 5(b) illustrates another example 550 wherein certain ablation spots 552 were not formed at all in the layer, such as may be the result of a defect in the workpiece or a failure of the respective laser pulse to reach the desired focus position with the necessary intensity for ablation.

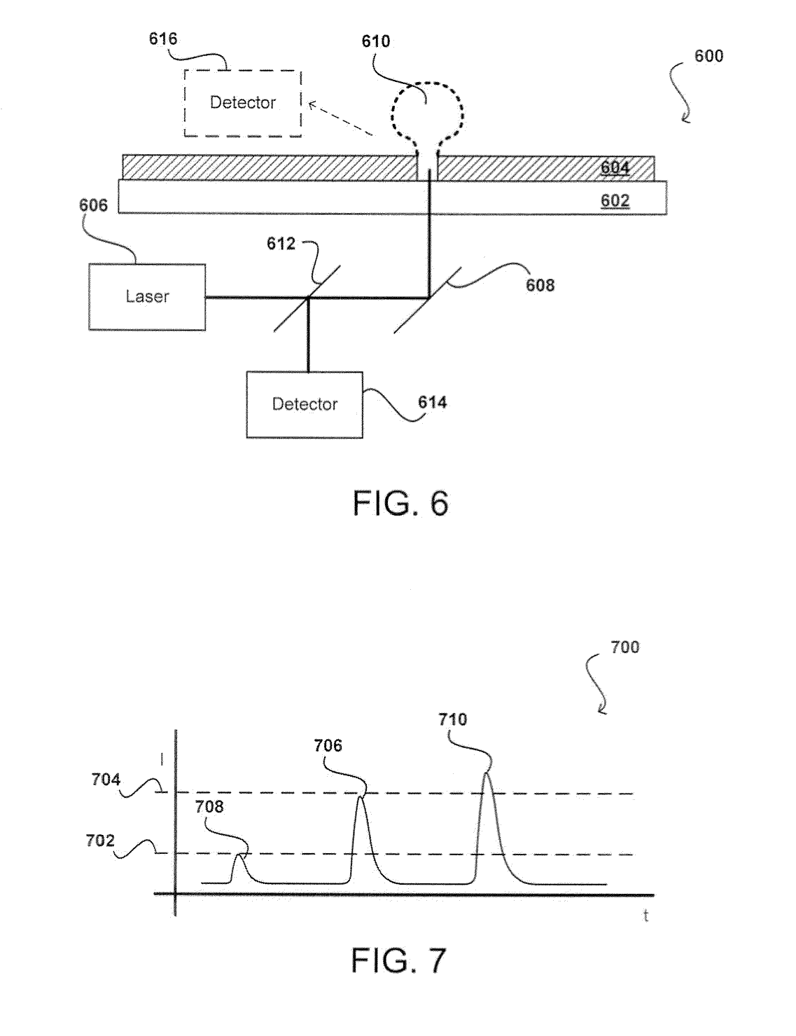

FIG. 6 illustrates a configuration 600 for forming these ablation spots that can be used in accordance with many embodiments. A pulse from a laser 606 is directed and/or focused by at least one optical element 608 through a substantially transparent (at least to the wavelength of the laser pulse) substrate 602 to the desired location in a layer 604 to be ablated. In some embodiments, the laser is a pulsed, Q-switched laser that operating with a frequency of about 30-150 kHz, operating at a wavelength on the order of about 266 nm, 532 nm, or 1064 nm. The layers of material are on the opposite side of the workpiece from the laser, such that the laser pulses pass through the substrate and ablate the layer(s) on the top side in this arrangement, thus causing the material at the focus location of the layer to ablate up and away from the surface. Typically, the laser is focused near the interface between layers. A laser pulse of sufficient intensity then causes the region to heat rapidly, causing a minor “explosion” that projects or bursts material from the workpiece. The material ablated from the surface generally forms a plume 610 of material, which can be extracted by the exhaust system. The plume in many embodiments has a duration on the order of about 1-3 μs. The “burst” is generally accompanied by a flash of light, such as a 1-10 mm high “spark,” caused by the rapidly heated gas, which can include white light as well as other spectral components. A trench, in many embodiments forming a substantially circular region free of material, is then formed in the area of the ablation.

As discussed, not every ablation occurs as desired, due to factors such as defects, variations, etc. When the ablation occurs as desired, the light given off with the burst of the plume, resulting from the heated gas, falls within a given range of intensity. When the ablation process is not intense enough to form a spot of sufficient size, the intensity of light generated with the burst will be below this desired range. Accordingly, an ablation step that produces too large a spot will have an intensity exceeding this range, and when no ablation occurs there will be no intensity as there is no burst or associated “spark” generated. Systems and methods in accordance with various embodiments utilize a detector to measure the intensity of the spark generated for each ablation position. By detecting the intensity at each ablation position, the system can determine which positions were not properly ablated, and can correct those positions as needed in order to ensure proper formation of the scribe lines. In the example of FIG. 6, light generated from the spark will travel back down the optical path toward the laser 606, and can be at least partially directed by an optical element 612 such as a partially transmissive mirror to an inline detector 614. The detector can be any appropriate detebtbr, such as a fast photodiode with a 10-15 ns response time. An example of such a detector is a white light spectrum PIN photodiode available from ThorLabs, Inc. of Newton, N.J. Another example of an appropriate detector is a photomultiplier tube (PMT). PMTs are extremely sensitive detectors of light in the ultraviolet, visible, and near-infrared ranges of the electromagnetic spectrum. PMTs multiply the signal produced by incident light by as much as 100 million times, enabling single photons to be detected individually when the incident flux of light is very low. A PMT can be used to detect a weaker plume that may require a detector more sensitive than a photodiode, such as for P2 and P3 plumes. TCO plumes (P1) can be detected using photodiodes. Placing the detector inline allows the detector to be substantially centered at all times with respect to the ablation spot. The detector can be synchronized with the firing of the laser 606 to capture the intensity of the burst at each time of ablation. In some embodiments there are about 10 μs between shots (or detections of consecutive plumes), with one shot per plume, for plumes that last about 1-3 μs. The duration between shots can be adjusted, but sufficient time can be left between plumes to allow each plume to sufficiently dissipate and allow the subsequent plume to be separately resolved. In some embodiments, gas can be flowed along, across, or sufficiently near the ablation spot in order to help disperse the material and thus reduce the lifetime of the plasma.

In some embodiments, a filter (not shown) can be added that will substantially prevent the detector from detecting light of the wavelength of the laser, in order to get a better indication of the intensity of the spark. As shown, a detector 616 can be placed in other positions, such as on the side of the ablation, but such positions can come with certain disadvantages in certain systems, as material from the ablation may collect on the detector, or there may be very little space in the scribing device in which to position the detector, particularly in complex devices with multiple ablation processes occurring concurrently in a compact area. In some embodiments, a shutter can be used in the path to the detector that is closed during firing of the laser.

The detector can be connected to, or in communication with, a controller such as is described in co-pending Provisional Patent Application Ser. No. 61/044,021, incorporated by reference above. In some embodiments, the detector captures positions where the intensity did not fall within the desired range. As illustrated in the example intensity vs. time graph 700 of FIG. 7, a range of desired intensity readings can be defined by a minimum-intensity value 702 and a maximum-intensity value 704. In some embodiments, the minimum-intensity value corresponds to the ablation threshold, or the minimum intensity needed to ablate the material. A peak 706 that falls within this range will in general correspond to a proper ablation resulting in an ablation spot of a size within a desired range. For a peak 708 that falls below the minimum intensity, the position can be recorded so that the device can return to the location to attempt to remove any discontinuity. For a peak 710 that falls above the maximum intensity, the system can attempt to adjust the intensity of the laser pulses to correct the amount of ablation. In some embodiments the captured position information can include coordinates of the system or workpiece. In some embodiments, the position information can include data such as a longitudinal count of the stage-drive motor and a lateral count of an optics-mount driver, etc. Any of a number of different approaches to recording position can be used as would be apparent to one of ordinary skill in the art in light of the teachings and suggestions contained herein.

The position information can be stored in any appropriate location, such as in local or cache memory. In order to conserve memory, the system may only record the position of intensity readings that fall outside the desired range, instead of intensity information for each point on a particular workpiece. A device controller in one embodiment is then able to use the position information to go back to the recorded positions of unacceptable intensity and attempt to ablate the position again in order to correct for the previous ablation attempt. In some embodiments, the discontinuities are fixed after the entire workpiece is ablated as desired. In other embodiments, the system can attempt to correct discontinuities on the same scribe line, or even shortly after discovering a discontinuity in order to minimize the travel time needed to navigate back to the position. Such an approach further allows any parameters to be adjusted to improve subsequent ablation, instead of waiting until the workpiece is finished.

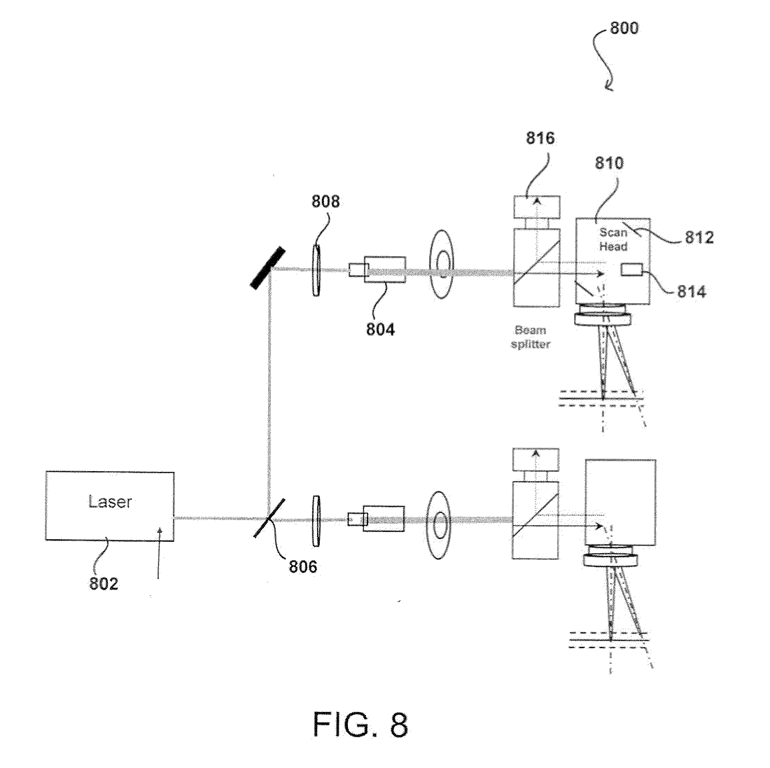

FIG. 8 illustrates a configuration 800 wherein a beam-splitting element 806, such as a partially-transmissive mirror, half-silvered mirror, prism assembly, etc., is used to split a laser pulse from a single laser 802 along two beam paths each to a separate scanner 810 to focus and/or position the pulse to the desired position and layer on the workpiece. While FIG. 8 illustrates some basic elements of an example laser assembly that can be used in accordance with many embodiments, it should be understood that additional or other elements can be used as appropriate. In this configuration, the pulse along each path passes through a shutter 808 to control the shape of each pulse, and then a beam expander 804 to adjust the cross-sectional area of the pulse to be focused onto the workpiece. Each beam portion can also pass through other appropriate elements, such as an auto-focusing element to focus the beam portion onto a scan head 810. Each scan head can include at least one element capable of adjusting a position of the beam, such as a galvanometer scanner useful as a directional deflection mechanism. In some embodiments, this is a rotatable mirror able to adjust the position of the beam along a lateral direction, orthogonal to the movement vector of the workpiece, which can allow for adjustment in the position of the beam relative to the intended scribe position. The scan heads then direct each beam concurrently to a respective location on the workpiece. A scan head also can provide for a short distance between the apparatus controlling the position for the laser and the workpiece. Therefore, accuracy and precision is improved.

In many embodiments, each scan head 810 includes a pair of rotatable mirrors 812, or at least one element capable of adjusting a position of the laser beam in two dimensions (2D). Each scan head can include at least one drive element 814 operable to receive a control signal to adjust a position of the “spot” of the beam within the scan field and relative to the workpiece. In one example, a spot size on the workpiece is on the order of tens of microns within a scan field of approximately 60 mm×60 mm, although various other dimensions are possible. When a scanning device or scan head is used, the controller can utilize positioning information from the scan head, longitudinal stage, and/or lateral drive platform to obtain the proper position information of each ablation spot on the workpiece. An inline camera 816 can be used to image the workpiece, for example, to image scribe lines and/or ablation plumes/sparks.

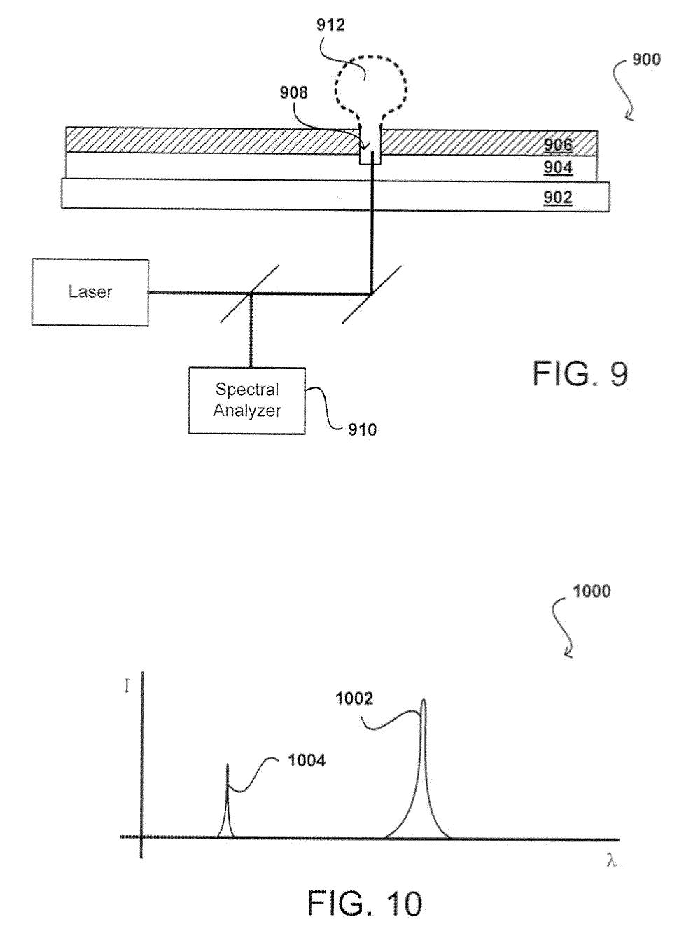

Analyzing the light given off by an ablation spark also provides a second level of process control. In addition to the diameter of an ablation spot, for example, an error also can be introduced when the laser is not properly focused so as to ablate only the proper layer. For example, consider the illustration 900 of FIG. 9. In this example, the pulse from the laser is intended to pass through the substrate 902 and bottom layer 904 and be focused at the top layer 906, typically near the interface with the underlying layer 904, in order to ablate a region in the top layer. Occasionally, however, the laser is focused at an improper depth in the workpiece, such as may be due to mechanical variations, defects in the workpiece, etc. The laser intensity may also be too high, etc. When this happens, the ablation may include material from other layers. As shown in the figure, the ablation not only occurs within the top layer 906, but a portion 908 of the underlying layer 904 is ablated as well. Such problems again can lead to problems with efficiency of the panel, and in some cases can even cause a cell not to function properly.

Systems and methods in accordance with many embodiments can detect such an issue in an approach similar to that described above, except instead of simply using a detector such as a fast photodiode, a spectral analyzer 910 or other such device can be used that is able to distinguish spectral components in the ablation plume 912. For example, a solar cell as described might have a metal back layer overlying an amorphous-silicon layer. In such a case, the system would expect the spectral analyzer to detect at least one peak 1002 in the spectral region(s) of the material used for the metal back layer, such as shown in the generic spectral graph 1000 of FIG. 10. The intensity of a peak corresponding to the flash still can be measured to determine the amount of ablation, as discussed above. In addition, however, the spectral analyzer is also able to detect and distinguish other peaks 1004 that might appear in the spectrum. Using the example above, the spectral analyzer might be able to detect in the spectrum the presence of silicon, or a silicon compound, which would indicate that the underlying layer was also being at least partially ablated. If the presence of material from a different layer persists for a significant amount of time, it is likely that the laser needs to be refocused and the problem is not simply due to a defect in the workpiece. The spectral results can be continually fed to a controller in some embodiments that is able to adjust the focus on-the-fly in order to improve process control.

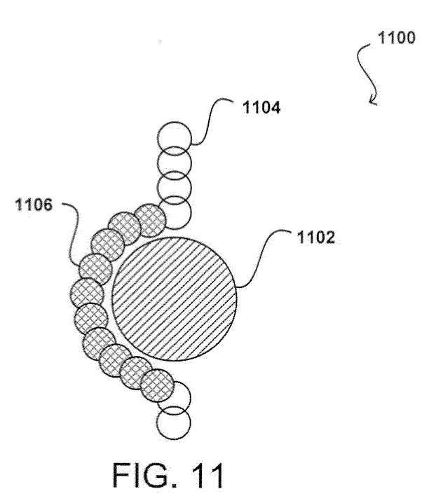

As discussed above, detecting problems with ablation spots can allow a device to go back, automatically or manually (or a combination thereof), and attempt to ablate the location again where the problem results in a discontinuity. Generally, this will involve translating back to that position and re-attempting ablation. Occasionally, however, the discontinuity will be due to a defect in the workpiece such as an air bubble in the substrate or a particle on a surface of the workpiece. In some cases, such a defect might cause several sequential ablation spots to not be formed properly. An approach 1100 to correcting discontinuities in accordance with some embodiments is illustrated in FIG. 11. Shown is a partial top view, showing a discontinuity in a scribe line 1104 formed by ablation spots, where the discontinuity overlies (or underlies) an air bubble or other defect in the workpiece. In this case, since the spots cannot be ablated due to the defect, a pattern of ablation spots 1106 can be determined that will circumvent the defect 1102. The determination of such a pattern can be done manually, by notifying a user to optically inspect the defect, or automatically through, for example, a camera and pattern recognition software, etc. As shown, the pattern can allow the scribe lines to be formed without discontinuities, and with a minimum amount of dead space created. Of course, if the defect is so large as to cover multiple cells, then there may be no way to salvage all of the cells. Further, once a defect gets to a certain size there may be more benefit to not spending time fixing the discontinuity and just giving up the efficiency of a single cell, etc.

Other process-control functions can further help improve the quality of the final scribe lines. For example, during the scribe process, an imaging device or profiler can image the pattern scribed on the workpiece to ensure proper control of the pulsed beam by the respective scan head. Further, while four lasers are shown with two beam portions each for a total of eight active beams in the examples, it should be understood that this is merely illustrative and that any appropriate number of lasers and/or beam portions can be used as appropriate, and that a beam from a given laser can be separated into as many beam portions as is practical and effective for the given application. Further, even in a system where four lasers produce eight beam portions, fewer than eight beam portions can be activated based on the size of the workpiece or other such factors. Optical elements in the scan heads also can be adjusted to control an effective area or spot size of the laser pulses on the workpiece, which in some embodiments vary from about 25 microns to about 100 microns in diameter.

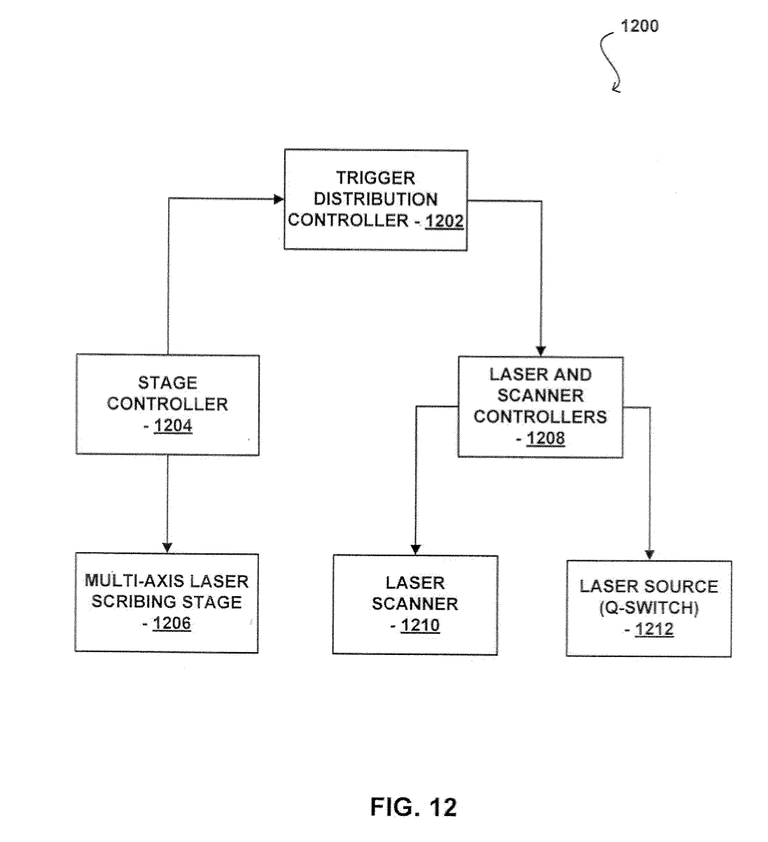

FIG. 12 illustrates a system 1200, in accordance with many embodiments, that can be used to enhance scribe-placement accuracy by synchronizing the stage-encoder pulses to the laser and spot-placement triggers. The system 1200 can ensure that the workpiece is in the proper position, and the scanners directing the beam portions accordingly, before the appropriate laser pulses are generated. Synchronization of all these triggers can be simplified by using a trigger-distribution controller 1202, such as a single VERSAmodule Eurocard (VME) controller, to drive all these triggers from a common source. The trigger-distribution controller 1202 receives a trigger signal from the stage controller 1204, which is used to control the movement of the workpiece via the multi-axis laser-scribing stage 1206. The trigger-distribution controller passes the trigger signal to the laser and scanner controllers 1208. The laser and scanner controllers 1208 use the trigger signal to synchronize the scanning of the laser and the switching of the laser via laser scanner 1210 and laser source (Q-switch) 1212, respectively. Various alignment procedures can be followed for ensuring alignment of the scribes in the resultant workpiece after scribing. Once aligned, the system can scribe any appropriate patterns on a workpiece, including fiducial marks and bar codes in addition to cell delineation lines and trim lines.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for scribing a workpiece, comprising:
a laser for directing a series of laser pulses toward a plurality of partially-overlapping positions on a layer of material on the workpiece, each laser pulse capable of triggering ablation of the layer of material at one of the positions; and
a detector for detecting an intensity of light generated during the ablation, the intensity of light being indicative of the amount of ablation at each respective position.

2. A system according to claim 1, wherein the detector comprises a photodiode.

3. A system according to claim 1, wherein the detector comprises a spectral analyzer able to detect material ablated from an adjacent layer of material on the workpiece.

4. A system according to claim 1, further comprising a filter to substantially prevent the detector from detecting light of a wavelength of the laser.

5. A system according to claim 1, further comprising a shutter disposed in the optical path of the detector, wherein the shutter is closed during the firing of the laser.

6. A system according to claim 1, further comprising a controller for directing the laser back to any position where the detected intensity indicates an unacceptable amount of ablation.

7. A system according to claim 1, wherein the workpiece is moved relative to the laser and further comprising a trigger-distribution controller for synchronizing the directing of the laser pulses with the movement of the workpiece.

8. A system according to claim 1, further comprising an imaging device for detecting the presence of a defect at any position where the detected intensity indicates an unacceptable amount of ablation.

9. A system according to claim 1, further comprising an algorithm for directing a series of laser pulses toward an additional plurality of positions in order to eliminate discontinuities at any position where the detected intensity indicates an unacceptable amount of ablation.

10. A method of scribing a workpiece, comprising:
directing a series of laser pulses toward a plurality of partially overlapping positions on a layer of material on the workpiece, each laser pulse capable of triggering ablation of the layer of material at one of the positions; and
detecting an intensity of light generated during the ablation, the intensity of light being indicative of the amount of ablation at each respective position.

11. A method according to claim 10, further comprising analyzing spectral components of material ablated from the workpiece in order to detect material ablated from an adjacent layer of material on the workpiece.

12. A method according to claim 10, further comprising directing the laser back to any position where the detected intensity indicates an unacceptable amount of ablation.

13. A method according to claim 12, further comprising re-ablating where the detected intensity indicates an unacceptably low amount of ablation.

14. A method according to claim 10, further comprising:
capturing an image of the workpiece where the detected intensity indicates an unacceptable amount of ablation; and
processing the image so as to identify a workpiece defect.

15. A method according to claim 14, further comprising generating a series of overlapping laser ablations so as to circumvent the workpiece defect.

16. An article comprising a storage medium having instructions stored thereon, which instructions when executed result in the performance of the following method:
directing a series of laser pulses toward a plurality of partially overlapping positions on a layer of material on the workpiece, each laser pulse capable of triggering ablation of the layer of material at one of the positions; and
detecting an intensity of light generated during the ablation, the intensity of light being indicative of the amount of ablation at each respective position.

17. An article according to claim 16, wherein the method performed further comprises analyzing spectral components of material ablated from the workpiece in order to detect material ablated from an adjacent layer of material on the workpiece.

18. An article according to claim 16, wherein the method performed further comprises directing the laser back to any position where the detected intensity indicates an unacceptable amount of ablation.

19. An article according to claim 18, wherein the method performed further comprises re-ablating where the detected intensity indicates an unacceptably low amount of ablation.

20. An article according to claim 16, wherein the method performed further comprises:
capturing an image of the workpiece where the detected intensity indicates an unacceptable amount of ablation; and
processing the image so as to identify a workpiece defect.

21. An article according to claim 20, wherein the method performed further comprises generating a series of overlapping laser ablations so as to circumvent the workpiece defect.
